(19) United States
(12) Patent Application Publication
(10) Pub. No.: US 2002/0171863 A1
(43) Pub. Date: Nov. 21, 2002

(54) Web-based demo pages for printers

(76) Inventor: Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/859,855

(22) Filed: May 16, 2001

(51) Int. Cl. G06F 15/00; G06K 1/00

(52) U.S. Cl. 358/1.15

(57) ABSTRACT

A method and system for providing web-based demo pages for printers is disclosed. The method includes accessing a remote computer having a list of printer demo pages, displaying the list of printer demo pages on a display device, and selecting one or more printer demo pages from the displayed list of printer demo pages. The method also includes receiving a download of one or more files associated with the one or more selected printer demo pages, and printing the one or more received files on a printer. The system includes a printer suitable for use with web-based printer demo pages. The printer includes a web server web page, a control panel, and a module. The web server web page is operable to execute on the printer and operable to provide access to a remote computer. The control panel is coupled to the printer and operable for selecting at least one printer demo page made accessible through the remote computer. The module is operable to execute on the printer and operable to receive the at least one printer demo page selected using the control panel over a network connection from the remote computer. The module is also operable to print the printer demo page on the printer.

### BACKGROUND

1. Field

The present invention relates generally to printers and, more particularly, printing demonstration pages on printers.

2. Description of the Related Art

Many personal computer printer manufacturers such as Hewlett-Packard (“HP”) provide demonstration pages (“demo pages”) for printing on their printers. The demo pages are printed to demonstrate the print quality, capabilities, and features of the printer. For example, printers are typically displayed and sold in retail stores. Customers who come to the retail stores to purchase a printer often print the demo pages on various makes and models of printers before making a purchasing decision. Demo pages play an important role in the respective printer's sales process.

In many printers, the demo pages are stored in internal memory, typically in printer ROM (Read Only Memory). The demo pages are stored as image files and are large and require a substantial amount of storage space in the printer ROM. This consumption of memory is expensive and other features and uses for the printer ROM are sacrificed to store the demo pages. This results in only having a limited number of demo pages or perhaps only a single demo page in the printer.

Because the demo pages are typically stored in printer ROM, the demo pages need to be developed early on in the printer development process. It is not uncommon for the printer's performance to be fine-tuned or altered subsequent to developing the demo pages and manufacturing the printer ROM. The demo pages in the printer ROM may not fully demonstrate or illustrate the subsequently enhanced performance characteristics of the printer, and thus, reduce the effectiveness of the demo pages in the sales process. Another printer ROM containing updated demo pages can be produced, but it may be infeasible to replace the printer ROM in the printers, and this further adds to the cost of the printers. Standalone demo ROMs may also be produced, but they must also be inserted into the printers, which presents the same issues as replacing the printer ROM, and additionally requires another dual in-line memory module (DIMM) slot.

Another drawback to having printer demo pages in printer ROM is that the demo pages can only be printed on the specific printer in which the printer ROM is installed. The demo pages cannot be printed on other printer models from either the same or a different printer manufacturer. Thus, a customer is not able to perform a comparison of the same demo page printed on various printers.

There exists a need to provide demo pages that may be printed on various printers in order to provide an accurate comparison of each printer's printing capabilities. There also exists a need to conveniently provide updated demo pages, for example, to illustrate and demonstrate the strengths of a manufacturer's printers while showing the weaknesses of the competitors' printers. Finally, it is desirable to provide a virtually unlimited number of demo pages available for printing on a printer without requiring comparable amounts of storage space in the printer.

### SUMMARY

The present disclosure is directed to systems and corresponding methods that facilitate the delivery of printer demo pages suitable for printing on one or more printers. The printer demo pages are stored on a computer, such as, by way of example, a web site that is accessible over the Internet. A printer connected to the Internet can access to the web site and receive a download of one or more printer demo pages for printing on the printer. A computer connected to the Internet can also access the web site and the printer demo pages. One or more printer demo pages can be downloaded to the computer, or to a printer coupled to the computer, for printing on the printer.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for providing printer demo pages includes: accessing a remote computer having a list of printer demo pages; displaying the list of printer demo pages; selecting one or more printer demo pages from the displayed list of printer demo pages; receiving a download of one or more files associated with the one or more selected printer demo pages; and printing the one or more received files on a printer.

In another embodiment, a method for downloading one or more printer demo pages onto a printer includes: selecting a printer demo page download option on a control panel coupled to a printer; accessing a web site using an embedded web server web page on the printer, the web site having a list of printer demo pages; displaying the list of printer demo pages on the control panel coupled to the printer; selecting one or more printer demo pages from the displayed list of printer demo pages; receiving the one or more selected printer demo pages; and storing the one or more selected printer demo pages in a memory device coupled to the printer.

In still another embodiment, a method for providing printer demo page update notifications includes: providing a listing of printer demo pages on a computer; detecting an update to the listing of printer demo pages; updating the listing of printer demo pages; determining whether to transmit a notification regarding the update to the listing of printer demo pages; and transmitting a notification regarding the update to the listing of printer demo pages in response to determining that the notification was necessary.

In yet another embodiment, a printer suitable for use with web-based printer demo pages includes a web server web page, a control panel, and a module. The web server web page is operable to execute on the printer and operable to provide access to a remote computer. The control panel is coupled to the printer and operable for selecting at least one printer demo page made accessible through the remote computer. The module is operable to execute on the printer and operable to receive the one printer demo page selected using the control panel over a network connection from the remote computer. The module is also operable to print the printer demo page on the printer.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 is a diagram illustrating an environment in which a system of the present invention may operate.

FIG. 2 illustrates exemplary components of a printer suitable for receiving a web-based printer demo page, according to one embodiment.

FIG. 3 a flow chart of an exemplary method for printing demo pages from a computer, according to one embodiment.

FIG. 4 a flow chart of an exemplary method for printing demo pages from a printer, according to one embodiment.

FIG. 5 a flow chart of an exemplary method for directly downloading and storing printer demo pages in a printer, according to one embodiment.

FIG. 6 a flow chart of an exemplary method for updating the web page listing the printer demo pages, according to one embodiment.

### DETAILED DESCRIPTION

Printer demo pages, according to an embodiment of the present invention, are provided on or made accessible through a readily accessible computer, such as the Hewlett-Packard (“HP”) web site. The web site can store the printer demo pages in a printer-ready uncompressed format (e.g., PCL, postscript, etc.) and/or in a compressed format, and potentially even a compressed hardware ready bit (“HRB”) format. The web site maintains and provides a list containing references to the printer demo pages that are accessible through the web site. Printers and computers with access to the Internet can connect to the web site, access the list of printer demo pages, and receive a download of one or more printer demo pages. The printer demo pages can then be printed on one or more printers.

In one embodiment, a printer can provide an embedded web server web page application. The embedded web server web page can be used to access and display a list of printer demo pages. The list of printer demo pages may be in local memory or on a web site that provides one or more printer demo pages. The list of printer demo pages can be displayed on the printer's control panel display device. A user can then use the printer's control panel and select one or more printer demo pages to download onto, or print on, the printer. The selected demo pages, if stored on the web site, are downloaded from the web site onto the printer.

The printer may store the downloaded printer demo pages on a coupled storage device such as, by way of example, a random access memory (RAM) disk, FLASH, printer hard disk, and the like. The stored printer demo pages can then be printed on the printer. Alternatively, the downloaded printer demo pages can be printed without being stored in the printer's storage device. In another embodiment, a computer coupled to the printer can be used to store the downloaded printer demo pages and used to initiate the printing of one or more printer demo pages on the printer.

Maintaining the printer demo pages on a web site makes an unlimited number of printer demo pages available for printing on a printer. The number of printer demo pages available to a printer for printing is not limited by the printer's memory. Moreover, the printer's memory need not be wasted for storing the large number of available printer demo pages. A printer need not dedicate any memory for storing printer demo pages, or can dedicate a relatively small amount of memory (as compared to the number of printer demo pages that can be printed on the printer) to store one or more printer demo pages, for example, to increase performance. Additionally, storing the printer demo pages in a printer-ready uncompressed format, or other format suitable for printing on multiple printers, allows for comparing the print quality of competing printers. This allows for a better, more accurate comparison of the quality of various printers.

Furthermore, maintaining printer demo pages outside a printer makes it easier to continuously update and modify the printer demo pages and still have the printer demo pages printed on the printer. Lead time (e.g., the time in the printer development cycle when the printer demo page has to be developed) on printer demo pages is reduced, allowing the printer demo pages to be better “tuned” to show the strengths of a printer. For example, the printer demo page can be continuously updated and modified to better demonstrate the strengths of a printer or a line of printers, while showing the weaknesses of one or more competing printers. Thus, a printer manufacturer can provide printer demo pages that enhance and highlight the qualities and features of its printers.

Because the printer demo pages can be continuously updated and modified, the printer demo pages can be used as a promotion mechanism. For example, a printer manufacturer can modify its printer demo pages to contain advertisements (“ads”) for the manufacturer's other products and services. The printer demo pages can also be modified to contain articles that promote or are favorable to the manufacturer's products and services. For example, the printer demo pages can be recent articles from trade magazines that praise the manufacturer's products or show awards presented or won by the manufacturer's products. Other time sensitive advertising information can also be provided, such as, by way of example, advertised sales or promotions.

Printer demo pages can demonstrate specific functions and/or performance features that are of interest to specific customers. For example, HP can develop printer demo pages for its direct customers who purchase printers directly from HP. HP can use the specially developed printer demo pages to demonstrate certain printer features that are of interest to a particular customer. By way of example, HP can develop printer demo pages that illustrate graphical image printing capabilities of its printers. HP can use these printer demo pages in demonstrations and presentations to its customers who are interested in purchasing printers for printing graphics and/or images.

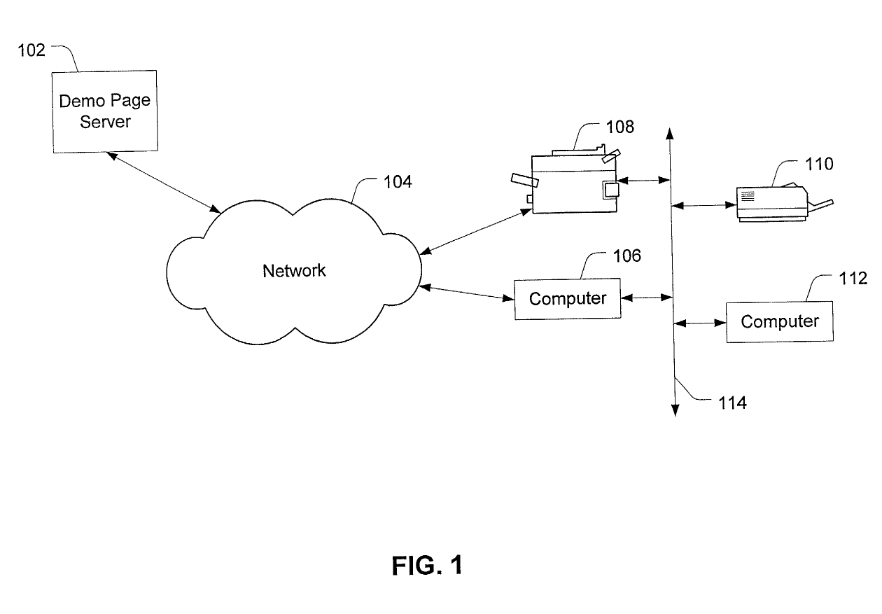

FIG. 1 is a diagram illustrating an environment in which a system of the present invention may operate. As depicted, the environment includes a demo page server 102, networks 104 and 114, computers 106 and 112, and printers 108 and 110. Demo page server 102, computer 106, and printer 108 are connected to network 104. Computers 106 and 112 and printers 108 and 110 are connected to network 114. As used herein, the terms “connected,” “coupled,” or any variant thereof, means any connection or coupling, either direct or indirect, between two or more elements; the coupling or connection between the elements can be physical, logical, or a combination thereof.

As used herein, the term “demo page server” is to be viewed as a designation of one or more computers and is not to be otherwise limiting in any manner. Demo page server 102 may, for example, be comprised of one or more program modules that execute on one or more computers employed as demo page server 102.

A computer, including the computers comprising demo page server 102, computers 106 and 112, and printers 108 and 110, may be any microprocessor or processor (hereinafter referred to as processor) controlled device such as, by way of example, personal computers, workstations, servers, clients, mini-computers, main-frame computers, laptop computers, a network of one or more computers, handheld computers, palm top computers, personal digital assistants, interactive wireless devices, printers, or any combination thereof. The computer may possess input devices such as, by way of example, a keyboard, a keypad, a control panel, a mouse, a microphone, or a touch screen, and output devices such as a computer screen, display screen, or a speaker. Additionally, the computer includes memory such as a memory storage device or an addressable storage medium.

The computer may be a uniprocessor or multiprocessor machine. Additionally the computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as, by way of example, read-only memory (ROM).

Demo page server 102 generally functions to facilitate access to one or more printer demo pages. In one embodiment, demo page server 102 provides or supports a web site that is accessible by electronic devices, including computer 106 and printers 108 and 110, that are connected to network 104. Demo page server 102 may provide one or more web pages that list the available printer demo pages. Demo page server 102 contains the necessary data and program logic to facilitate the selection and downloading of one or more printer demo pages selected from the list of available printer demo pages.

A printer demo page may be implemented as one or more files (e.g., printer demo page files). The files may be page description language files (e.g., postscript, printer control language (PCL), etc.) that are uncompressed and ready for printing on printers that support the particular page description language. The files may also be in a compressed format (to facilitate faster downloading), and even in a compressed hardware ready bit (HRB) format. The files may be stored on demo page server 102 and/or one or more computers coupled to demo page server 102. If a printer demo page stored on demo page server 102 needs to be downloaded to a printer, demo page server 102 retrieves the one or more files associated with the printer demo page from, for example, a locally coupled storage device and transmits the retrieved files to the printer.

Alternatively, if a printer demo page stored on a remotely coupled computer needs to be downloaded to the printer, demo page server 102 requests and receives the one or more files associated with the printer demo page from the remotely coupled computer, and transmits the received files to the printer. In another embodiment, demo page server 102 can request that the remotely coupled computer download the one or more files associated with the printer demo page directly to the printer. “Printer demo page,” “printer demo page file,” and “the one or more files comprising the printer demo page” are used interchangeably herein. For example, “downloading a printer demo page” is understood to mean “downloading the one or more files associated with or comprising the printer demo page.”

Network 104 generally functions to facilitate the transmission of electronic content between electronic devices coupled to network 104. In one embodiment, network 104 includes the Internet. The Internet is a global network connecting millions of computers, including demo page server 102, computer 106, and printer 108. The structure of the Internet, which is well known to those of ordinary skill in the art, is a global network of computer networks and utilizes a simple, standard common addressing system and communications protocol known as Transmission Control Protocol/Internet Protocol (TCP/IP). The connections between different networks are called “gateways,” and the gateways serve to transfer electronic data worldwide.

One part of the Internet is the World Wide Web (WWW or Web). The Web is generally used to refer to both (1) a distributed collection of inter-linked, user-viewable hypertext documents (commonly referred to as “web documents” or “web pages” or “electronic pages” or “home pages”) that are accessible via the Internet, and (2) the client and server components which provide users access to such documents using standardized Internet protocols. The web documents are typically encoded using Hypertext Markup Language (HTML) and the primary standard protocol for allowing the components to locate and acquire web documents is the Hypertext Transfer Protocol (HTTP). However, as used herein, the term Web is intended to encompass future languages and protocols, which may be used in place of, or in addition to, HTML and HTTP.

The Web contains different computers that store and serve web pages, such as HTML documents, capable of displaying textual and graphical information on a computer screen. These computers are generally referred to as “web sites.” A web site is accessed through a unique Internet address (e.g., Uniform Resource Locator or URL) that corresponds to a web page within the web site. The web page may advantageously organize the presentation of text, graphical images, video, and audio, as well as provide links to other web pages in the web site or the Web. Furthermore, the web page may be implemented as a conduit for the dissemination of data and information from the web site as well as the receipt of data and information into the web site.

One of ordinary skill in the art will appreciate that the Internet may advantageously be comprised of one or a combination of other types of networks without detracting from the scope of the invention. The Internet can include, by way of example, local area networks (LANs), wide area networks (WANs), public internets, private intranets, a private computer network, a secure internet, a private network, a public network, a value-added network, interactive television networks, wireless data transmission networks, two-way cable networks, satellite networks, interactive kiosk networks, and/or any other suitable data network.

Computer 106 generally functions to facilitate access to demo page server 102 over network 104. In one embodiment, computer 106 supports a client application, such as a browser, that is executed and used to access computers coupled to network 104. The browser is a software program that allows a user to access different computers, including demo page server 102, connected to network 104. In one embodiment, the browser may be a standard browser such as the Netscape Navigator® developed by Netscape, Inc., the Microsoft Internet Explorer® developed by Microsoft Corporation, a WebTV, an embedded web browser on a handheld device, or the like. In another embodiment, other types of access software, such as, by way of example, other types of Internet browsers, custom network browsers, communication software, cable modem software, point-to-point software, multi-point software, custom emulation software, and the like, could be used to implement the browser.

In one embodiment, computer 106 can function as a repository for one or more of the printer demo pages available on demo page server 102. For example, a user can display the list of printer demo pages accessible through demo page server 102, specify or indicate one or more desired printer demo pages, and select an option to download the specified printer demo pages onto computer 106. Computer 106 can receive the download of the specified printer demo pages and store the printer demo pages on a storage device, such as a hard disk, that is coupled to computer 106. The user can then display a list of printer demo pages that are locally stored on computer 106, select one or more desired printer demo pages, and select an option to print the desired printer demo pages, for example, on either printer 108 or 110, or both printers 108 and 110. If the user does not see a desired printer demo page, the user can select an option to display the list of printer demo pages available on demo page server 102 and select one or more printer demo pages from the displayed list.

In another embodiment, computer 106 can provide access to demo page server 102 and, in particular, the list of printer demo pages accessible through demo page server 102, without providing the storage function. For example, a user can display the list of printer demo pages accessible through demo page server 102, specify or indicate one or more desired printer demo pages, and select an option to print the specified printer demo pages on one or more printers. Computer 106 can receive the download of the specified printer demo pages and transmit the downloaded printer demo pages to the specified printers for printing.

For example, network 114 and the devices connected to network 114 may be located in a retail computer store. A user (e.g., a sales associate, a customer, etc.) can execute a browser on computer 106 and display a list of locally stored printer demo pages on a display device coupled to computer 106. If the user sees a printer demo page in the list that the user wants printed, the user can select the printer demo page and request to have the printer demo page printed on, for example, one or more printers connected to network 114.

Alternatively, if the user does not see a printer demo page in the list of locally stored printer demo pages, or if computer 106 does not provide local storage of printer demo pages, the user can execute the browser and access demo page server 102 over network 104. The user can then access the one or more web pages containing the list of printer demo pages that are available on demo page server 102. The list of printer demo pages is displayed on the display device coupled to computer 106. The user can then browse the list of printer demo pages and select one or more printer demo pages from the list. Depending on the capability of computer 106, the user can request a download of the selected printer demo pages onto computer 106, or request that the selected printer demo pages be printed on one or more printers coupled to computer 106, for example, either directly or via network 114.

Printer 108 can facilitate access to demo page server 102 over network 104. In one embodiment, printer 108 supports an embedded web server web page application that is executed and used to access demo page server 102. The embedded web server web page can be accessed through a control panel that is coupled to printer 108. The embedded web server web page is a limited function browser that provides access to web pages. The web pages can be local (e.g., stored in printer 108) or remote, for example, a web page or web pages on demo page server 102. For example, a user can use the embedded web server web page to access the web page in demo page server 102 containing the list of printer demo pages and display the list (e.g., web page) on a display device coupled to printer 108. The user can then use the control panel to select one or more printer demo pages from the list and request to have the selected printer demo pages printed on printer 108. In another embodiment, printer 108 can provide local storage of printer demo pages in a manner similar to that provided by computer 106.

As depicted, printer 108 is coupled to and accessible over network 114. Network 114 facilitates the transmission of electronic content between electronic devices coupled to network 114. For example, network 114 may be a local area network typically found in retail stores that sell electronic equipment, including computers and printers. Thus, electronic devices, such as computers 106 and 112, coupled to network 114 can access printers 108 and 110. For example, a user can use computer 106 to request the printing of a printer demo page on printer 108. Printer 110 is also coupled to and accessible over network 114, and electronic devices coupled to network 114 can access printer 110. Thus, a user can use computer 106 to submit a print request to printer 110.

Assuming that printers 108 and 110 are competing models manufactured by two different printer companies, a user interested in comparing the printing quality of the two printers can print one or more printer demo pages on both printers 108 and 110. For example, the user can display a list of printer demo pages on computer 106 and select one or more printer demo pages the user wants printed on both printers 108 and 110. The user can then select an option to have the selected printer demo pages printed on both printers 108 and 110. Computer 106 can then transmit the selected printer demo pages to printers 108 and 110 for printing.

Those of ordinary skill in the art will appreciate that in certain embodiments of the present invention, printer 108 need not be coupled to and accessible over network 114. Rather, one or more other printers may be coupled to network 114, and thus, enable a user to print one or more printer demo pages on multiple printers to compare the print quality of the various printers.

Computer 112 is coupled to network 114 and can be used to access electronic devices, such as computer 106 and printers 108 and 110, coupled to network 114. For example, a user can use computer 112 to access computer 106 and, in particular, a list of printer demo pages stored on computer 106. The user can display the list of printer demo pages on a display device coupled to computer 112 and select one or more printer demo pages for printing on either or both printers 108 and 110. In one embodiment, computer 112 may provide a storage function for one or more printer demo pages stored on computer 106.

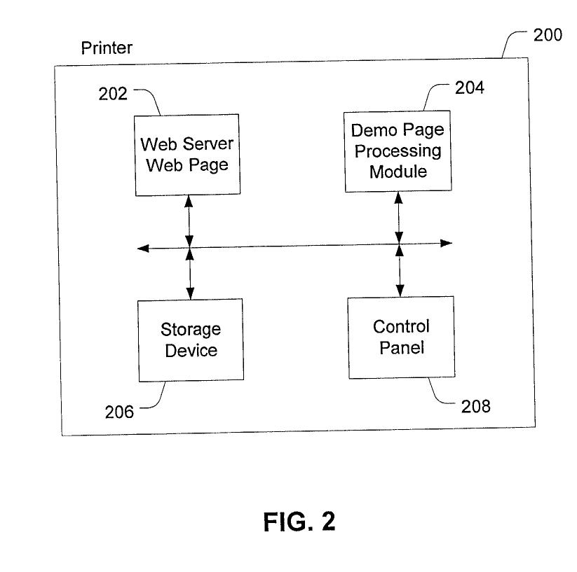

FIG. 2 illustrates exemplary components of a printer 200 suitable for receiving a web-based printer demo page, according to one embodiment. As depicted, printer 200 includes a web server web page 202, demo page processing module 204, storage device 206, and control panel 208. Web server web page 202 generally functions to provide a user interface through which a list of printer demo pages are presented to a user. Web server web page 202 contains program logic to receive and display a list of printer demo pages on, for example, control panel 208.

In one embodiment, web server web page 202 comprises a limited function, mini browser, which provides access to and displays one or more web pages. The web pages can contain a list of printer demo pages. The list of printer demo pages may be a listing of the printer demo pages that are locally stored on the printer 200. In this instance, the list of printer demo pages can be maintained or displayed through one or more locally stored web pages that can be processed by web server web page 202. Alternatively, the list of printer demo pages may be a listing of the printer demo pages that are accessible through demo page server 102. In this instance, web server web page 202 provides access to demo page server 102 and, in particular the web pages listing the printer demo pages accessible through demo page server 102. For example, the web pages listing the printer demo pages are received from demo page server 102 and processed by web server web page 202.

In general terms, demo page processing module 204 facilitates the printing of printer demo pages on printer 200. Demo page processing module 204 contains program logic to retrieve or receive one or more printer demo pages and submit the printer demo pages for printing on printer 200. For example, for locally stored printer demo pages, demo page processing module 204 can receive one or more identifiers that respectfully identify one or more printer demo pages. Demo page processing module 204 can then retrieve the identified printer demo pages from, for example, storage device 206 and submit the printer demo pages for printing on printer 200.

Alternatively, demo page processing module 204 can receive one or more printer demo pages from a remote device, such as, by way of example, computer 106 and/or demo page server 102. These printer demo pages may be received over connections such as networks 104 and/or 114. Demo page processing module 204 can then submit the received printer demo pages to be printed on printer 200. Depending on the functionality and capability of printer 200, in some embodiments, demo page processing module 204 can locally store received printer demo pages in, for example, storage device 206. Demo page processing module 204 can update the list of printer demo pages to reflect the changes to the locally stored printer demo pages. For example, one or more previously stored printer demo pages may have been removed to accommodate the storing of one or more recently stored printer demo pages.

Storage device 206 facilitates storage of electronic content in printer 200. Storage device 206 generally functions to store data and information to enable the printing of printer demo pages on printer 200. Storage device 206 may be implemented with one or more addressable storage media, such as, by way of example, random access memory (RAM), RAM disk, Flash, printer hard disk, or other suitable storage facility compatible for use in or with printer 200. For example, storage device 206 may store the program logic that facilitate the printing of printer demo pages and the display of web pages that contain the list of printer demo pages. Storage device 206 may also function as a local store for one or more printer demo pages.

Control panel 208 generally functions as an input/output device on printer 200. Control panel 208 typically includes one or more keys and a display device. The keys may be used to provide input to printer 200, and the display device may be used to display information, including the list of printer demo pages. For example, a user can use control panel 208 to initiate the printing of one or more printer demo pages on printer 200. The list of printer demo pages is displayed to the user on the display device or other display component of control panel 208. The user can input a sequence of one or more keystrokes on control panel 208 to view, select, and initiate the printing of one or more printer demo pages. The user can also use control panel 208 to provide other information and data to facilitate the printing of printer demo pages on printer 200 as disclosed herein.

Those of ordinary skill in the art will appreciate that the functionality provided by the components and modules of printer 200 may be combined into fewer components or modules, or further separated into additional components and modules. Additionally, in certain embodiments, printer 200 may not provide some of the functionality described herein.

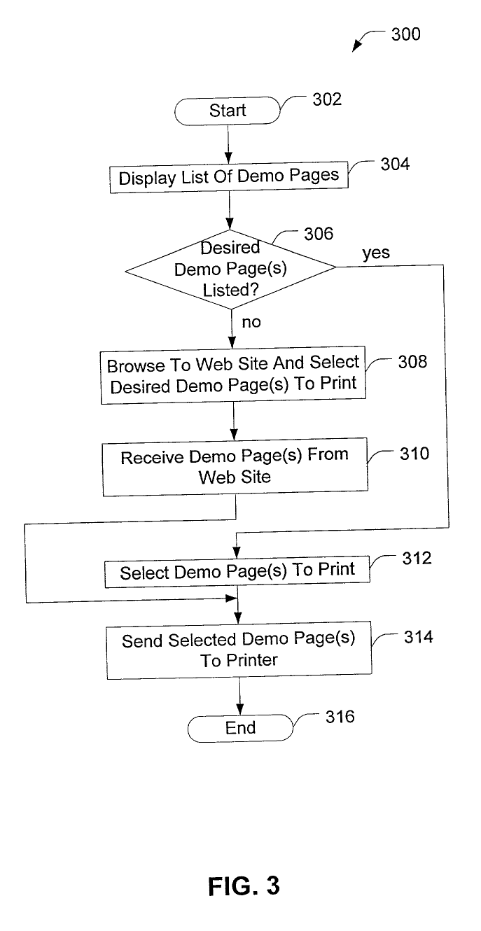

FIG. 3 a flow chart of an exemplary method 300 for printing demo pages from a computer, according to one embodiment. Beginning at a start step 302, a user (e.g., a sales associate, consumer, etc.) is interested in printing one or more printer demo pages to examine the print quality and/or features of one or more printers. For example, a person may be interested in purchasing a printer from a retail store. At the store, the person may want to print printer demo pages on one or more printers he or she is considering to decide which printer to purchase. The person, for example, with assistance from a sales associate, may initiate the printing of printer demo pages from a personal computer in the store that is normally used to print printer demo pages.

Assuming that computer 106 is located in the store and is a computer suitable for printing printer demo pages, the user can display a list of printer demo pages on a display device coupled to computer 106 (step 304). The list of printer demo pages may identify the printer demo pages that are currently stored in computer 106. The list of printer demo pages may include thumbnail depictions of the printer demo pages. The user can browse the displayed list of locally stored printer demo pages and determine if he or she wants to print one or more of the printer demo pages appearing in the list.

The user can indicate whether he or she wants to print one or more locally stored printer demo pages (step 306). If the user finds printer demo pages to print in the displayed list, the user can select one or more printer demo pages (step 312), specify one or more printers that the user wants to print the selected printer demo pages, and select an option to print. Computer 106 can then initiate the printing of the selected printer demo pages on the specified printers by sending the associated printer demo page files to the specified printers (step 314). In one embodiment, computer 106 can display a list of printers that are coupled to computer 106. Assuming that the list of printers includes the printers that the user is interested in, the user can select the printers he or she wants to compare (e.g., the printers that the user wants to print the printer demo page) from the list of printers.

Alternatively, if the user does not find a suitable printer demo page in the list to print, the user can select an option to view printer demo pages stored on a remote computer. Selecting this option may cause a browser to execute on computer 106. The user can then use the browser to browse to a web site, for example, demo page server 102, and browse one or more web pages that contain a list of printer demo pages that are available on the web site (step 308). In particular, the user can browse the list of printer demo pages and select one or more printer demo pages from the list.

In one embodiment, computer 106 may present a list of web sites that provide access to printer demo pages. For example, various printer manufacturers may provide such web sites. The user can then select the appropriate web site from the displayed list. Alternatively, the user may be able to enter a URL for a web site in the browser. Having selected the printer demo pages, the user can select an option to download the printer demo pages onto computer 106.

Assuming the user is browsing demo page server 102, demo page server 102 downloads the selected printer demo pages (e.g., the files associated with the selected printer demo pages) to computer 106 (step 310). Computer 106 may prompt the user to specify one or more printers that the user wants to print the received printer demo pages. The user can specify the desired printers, and computer 106 can send the received printer demo page files to the specified printers for printing (step 314). Having sent the printer demo pages to the specified printers for printing, computer 106 ends processing (step 316).

In one embodiment, computer 106 may locally store the received printer demo page files in a coupled storage device, such as a hard disk, for subsequent use. Computer 106 can then update the list of locally stored printer demo pages. The user, or other users, can then select the printer demo pages from the list of locally stored printer demo pages and select an option to have the selected printer demo pages on one or more coupled printers.

Those of ordinary skill in the art will appreciate that, for this and other methods disclosed herein, the functions performed in the exemplary flow charts may be implemented in differing order. Furthermore, steps outlined in the flow charts are only exemplary, and some of the steps may be optional, combined into fewer steps, or expanded into additional steps without detracting from the essence of the invention.

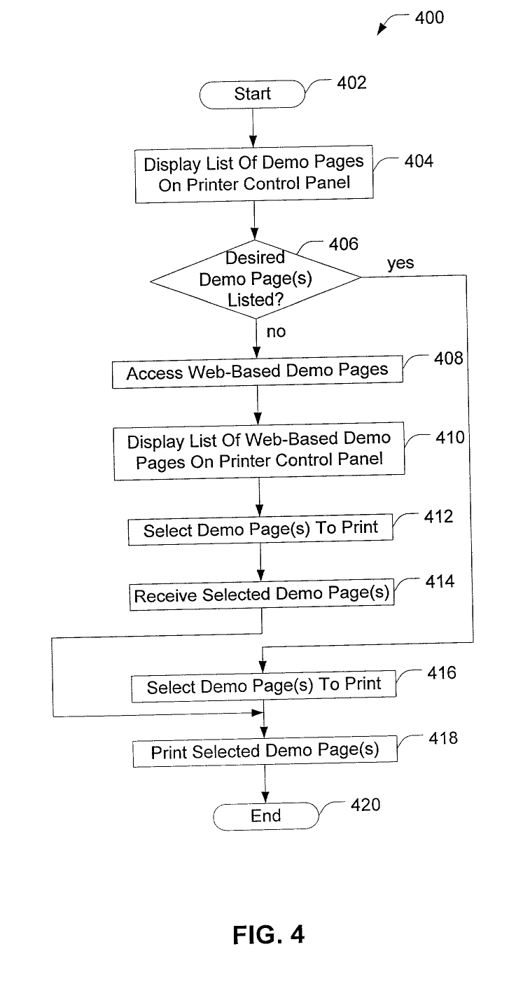

FIG. 4 a flow chart of an exemplary method 400 for printing demo pages from a printer, according to one embodiment. Beginning at a start step 402, a user is interested in printing one or more printer demo pages to examine the print quality of a printer. For example, a person may be interested in purchasing a printer from a retail store. At the store, the person may want to print demo pages on the printers he or she is considering purchasing to determine the printer's quality.

Assuming that printer 108 is located in a store and is the printer the person is interested in purchasing, the user (e.g., the person or a sales associate) can display a list of printer demo pages on a display device coupled to the printer (step 404). The display device may be in or be a part of the printer's control panel. The list of printer demo pages may identify the printer demo pages that are currently stored in printer 108 and that are available for printing. The user can browse the displayed list of locally stored printer demo pages and determine if he or she wants to print one or more of the printer demo pages in the list.

The user can indicate whether he or she wants to print one or more locally stored printer demo pages (step 406). If the user finds printer demo pages the user wants printed, the user can select one or more printer demo pages from the list (step 416) and select an option to print. Printer 108 can then print the selected printer demo pages (step 418).

Alternatively, if the user does not find any printer demo page to print in the list, or printer 108 does not provide locally stored printer demo pages for printing, printer 108 may present the user an option to view printer demo pages stored on a remote computer. Selecting this option may cause a browser, for example, web server web page 202, to browse to a web site that provides access to printer demo pages (step 408). In one embodiment, web server web page 202 browses to a predetermined web page on a predetermined web site. For example, HP may provide printer demo pages on HP's web site, and web server web page 202 on HP printers may be programmed or set to browse to HP's web site.

Printer 108 can display the list of printer demo pages (e.g., the web page containing the list of printer demo pages) accessible through the web site on the display device coupled to printer 108 (410). The user can then use the control panel on printer 108 and browse the list of printer demo pages and select the printer demo pages that the user wants printed (step 412). Printer 108 receives from the web site the printer demo page files associated with the selected printer demo pages (step 414), prints the received printer demo pages (step 418), and ends processing (step 420).

In one embodiment, printer 108 may locally store the received printer demo page files in a coupled storage device, such as storage device 206, for subsequent use. Printer 108 can then update the list of locally stored printer demo pages. For example, one or more printer demo page files previously stored in storage device 206 may need to be removed to store the more recently received printer demo page files. Printer 108 can then delete the references to the removed printer demo pages in the list of locally stored printer demo pages, and update the list to include references to the recently stored printer demo pages.

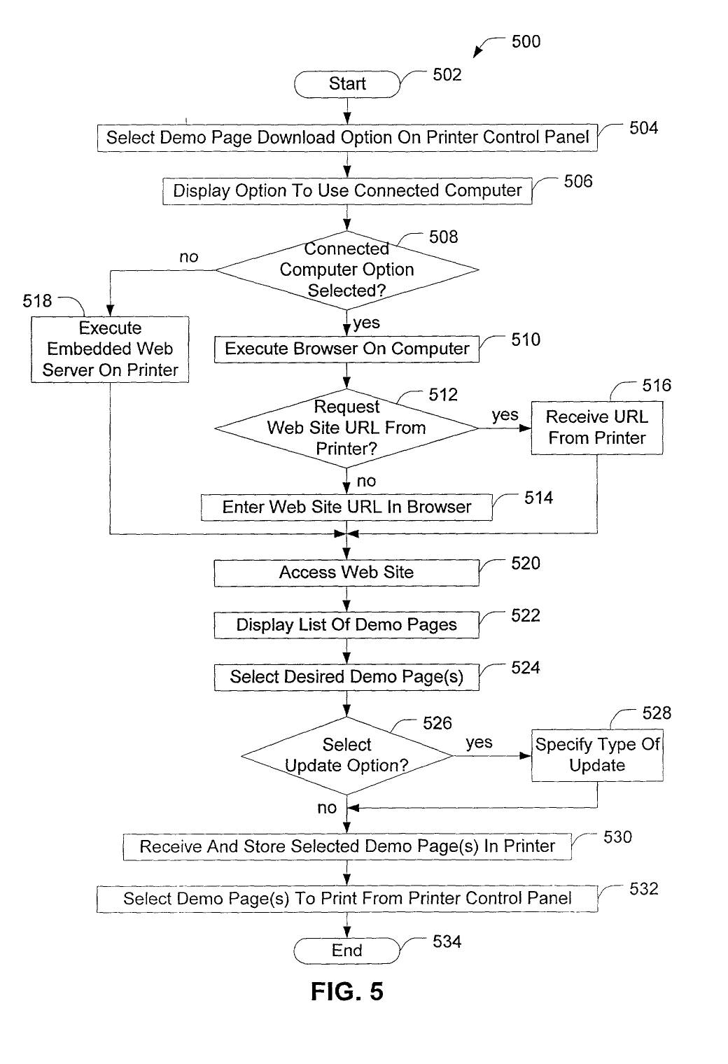

FIG. 5 a flow chart of an exemplary method 500 for directly downloading and storing printer demo pages in a printer, according to one embodiment. Beginning at a start step 502, a user, such as a sales associate, is interested in downloading one or more remotely stored printer demo pages for storage on a printer. For example, the user may be interested in storing in a HP LaserJet® printer, recently developed printer demo pages that better illustrate the printers features. Alternatively, HP may be having a promotion and the user may want to store in the HP printer, recently designed printer demo pages that explain the HP promotion.

The user can select an option, for example, on the printer's control panel to download printer demo pages that are stored on a web site (step 504). In one embodiment, the printer may provide the user an option to use a computer coupled to the printer to request the downloading of the printer demo pages from the web site (step 506). For example, it may be more convenient for the user to use a computer rather than the printer's control panel to select and request the downloading of printer demo pages from the web site. The printer determines if the user selects the option to use the coupled computer (step 508).

If the user does not select the option to use the coupled computer, or if the printer does not support the use of a coupled computer, the printer executes an embedded web server (step 518). In one embodiment, the embedded web server browses to a predetermined web site. In other embodiments, the printer may execute other program logic that provides access to a web site that provides access to printer demo pages.

Alternatively, if the user selects the option to use a coupled computer, the user may execute a browser program on the computer (step 510). In one embodiment, the browser program may contain program logic to request the URL of a web site to connect to from the printer. In this embodiment, the browser program may provide the user an option to request the URL of the web site from the printer (step 512). If the user selects the option for the browser to request the URL from the printer, the browser requests and receives the URL (e.g., a predetermined URL) from the printer (step 516). Alternatively, the user may elect to enter the URL for a web site in the browser (step 514). Here, the user may be able to provide a URL of not only the printer manufacturer's web site, but other web sites that contain or provide access to printer demo pages that are suitable for printing on the printer.

The user, either by using the printer's control panel or the computer coupled to the printer, accesses the web site (step 520). The user browses the web site and, in particular, the web pages containing the list of printer demo pages, and displays the list of printer demo pages (step 522). The user selects one or more printer demo pages from the list to download onto the printer (step 524). The user may be presented with an option to receive update information regarding the selected printer demo pages from the web site (step 526). If the user selects the option to receive update information/notification, the user may be prompted to specify the type of notification and the content of the notification.

In one embodiment, the user may be prompted to select from a list of supported notifications. For example, the list may provide an option to receive an email notification, an email notification that includes the updated printer demo page file associated with the update printer demo page, a fax notification, a direct download of the updated printer demo page file onto the printer, and the like. The user can then specify the type of updates the user wants to receive (step 528). Depending on the selected type of update, the user may be further prompted to provide additional information such as, by way of example, email address, telephone number, fax number, network address for the printer, and the like.

Having selected one or more printer demo pages from the list, the user can select an option to have the printer demo page files associated with the selected printer demo pages downloaded onto the printer. The printer receives the printer demo page files and stores the printer demo page files in a coupled memory device (step 530). The printer updates the list of locally stored printer demo pages to reflect the newly received and stored printer demo page files. If the printer removed any previously stored printer demo page files, the reference to the removed printer demo page files is deleted from the list of locally stored printer demo pages. The user can then request to view the list of locally stored printer demo pages and select one or more printer demo pages to print (step 532). The printer prints the specified printer demo pages and ends processing (step 534).

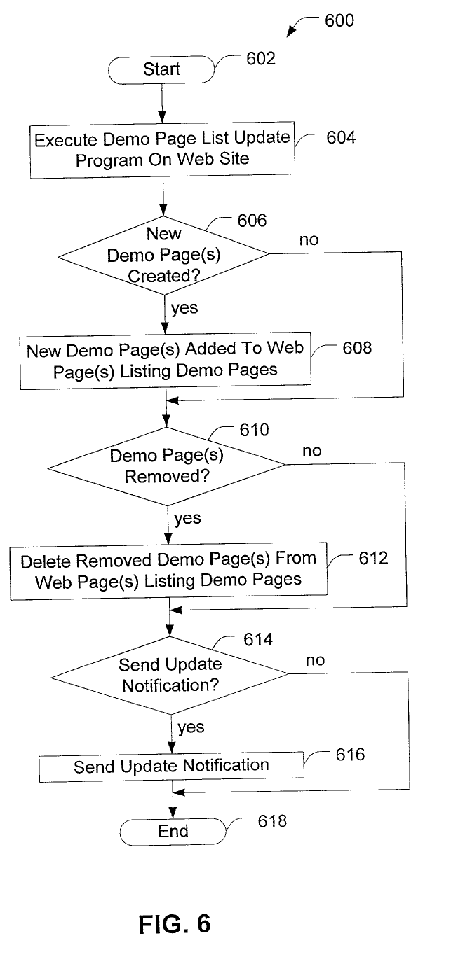

FIG. 6 a flow chart of an exemplary method 600 for updating the web page listing the printer demo pages, according to one embodiment. Beginning at a start step 602, a web site providing access to printer demo pages is updated. For example, HP may provide a web site that provides access to printer demo pages that are suitable for printing on both HP and non-HP printers. HP may have developed new printer demo pages for their printers. A provider or operator/administrator of the HP web site can store the newly created printer demo page files in a storage device coupled to the web site. The provider can also remove any printer demo page files that are not to be used from the storage device.

The provider can execute a printer demo page list update program on the web site to update the list of printer demo pages to reflect the addition or removal of printer demo page files in the web site (604). The update program may provide an option to add to the web pages containing the list of printer demo pages references to one or more printer demo pages (step 606). If the provider selects the option to add printer demo pages to the list of printer demo pages, the update program may prompt the user to provide identification information, such as, by way of example, URL, filename, descriptive name, thumbnail URL, and the like, that identifies the printer demo page files and that can be included in the list of printer demo pages. The update program adds the references to the added printer demo pages to the web pages that contain the list of printer demo pages (step 608).

The update program may provide an option to remove one or more printer demo page references from the web pages that contain the list of printer demo pages (step 610). If the provider selects the option to remove printer demo page references from the list of printer demo pages, the update program may prompt the user to provide information that identifies the printer demo page references to remove from the list of printer demo pages. The update program removes the references to the removed printer demo pages from the web pages that contain the list of printer demo pages (step 612).

The update program can determine if it should send any update notifications (step 614). In one embodiment, the web site may maintain one or more records that identify the recipients that are to receive update notifications. For example, a record containing a list of recipients to notify can be associated with each printer demo page listed on the web pages on demo page server 102. The record can also identify the type of notification, the address of the recipient, and the content of the notification. The update program can retrieve the record or records associated with each updated printer demo page (e.g., any added or removed printer demo pages), create the appropriate notification, and send the update notification to the necessary recipients (step 616). The update program processes the update notification for each updated printer demo page and ends processing (step 618).

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A method for providing printer demo pages comprising:
accessing a remote computer comprising a list of printer demo pages;
displaying the list of printer demo pages;
selecting one or more printer demo pages from the displayed list of printer demo pages;
receiving a download of one or more files associated with the one or more selected printer demo pages; and
printing the one or more received files on a printer.

2. The method of claim 1, wherein the remote computer is accessed using a computer coupled to the remote computer.

3. The method of claim 1, wherein the remote computer is accessed using a control panel coupled to the printer.

4. The method of claim 1, wherein at least one of the one or more files being in printer-ready uncompressed format.

5. The method of claim 1, wherein at least one of the one or more files being in a compressed format.

6. The method of claim 1, wherein the remote computer comprising a web site accessed via the Internet.

7. The method of claim 1 further comprising storing the one or more files on the printer.

8. The method of claim 1 further comprising storing the one or more files on a computer coupled to the printer.

9. The method of claim 1, wherein at least one of the printer demo pages listed in the list of printer demo pages is an advertisement.

10. A method for downloading one or more printer demo pages onto a printer comprising:
selecting a printer demo page download option on a control panel coupled to a printer;
accessing a web site using an embedded web server web page on the printer, the web site comprising a list of printer demo pages;
displaying the list of printer demo pages on the control panel coupled to the printer;
selecting one or more printer demo pages from the displayed list of printer demo pages;
receiving the one or more selected printer demo pages; and
storing the one or more selected printer demo pages in a memory device coupled to the printer.

11. The method of claim 10 further comprising:
selecting one or more of the received printer demo pages; and
printing the one or more selected printer demo pages.

12. The method of claim 10 further comprising specifying an update option to receive notifications of changes to the one or more received printer demo pages.

13. The method of claim 10, wherein at least one of the one or more received printer demo pages being in printer-ready uncompressed format.

14. The method of claim 10, wherein at least one of the one or more received printer demo pages being in compressed format.

15. The method of claim 10 further comprising:
selecting an option to use a computer coupled to the printer;
accessing the web site using a web browser executing on the computer;
displaying the list of printer demo pages on a display device coupled to the computer; and
selecting the one or more printer demo pages from the list of printer demo pages displayed on the display device coupled to the computer.

16. The method of claim 15 further comprising receiving at the computer a URL for the web site from the printer.

17. A method for providing printer demo page update notifications comprising:
providing a listing of printer demo pages on a computer;
detecting an update to the listing of printer demo pages;
updating the listing of printer demo pages;
determining whether to transmit a notification regarding the update to the listing of printer demo pages; and
transmitting a notification regarding the update to the listing of printer demo pages in response to determining that the notification was necessary.

18. The method of claim 17, wherein the update comprises a modification to at least one printer demo page listed in the listing of printer demo pages.

19. The method of claim 17, wherein the update comprises a new printer demo page added to the listing of printer demo pages.

20. The method of claim 17, wherein the update comprises a removal of at least one printer demo page from the listing of printer demo pages.

21. The method of claim 17, wherein the notification comprising an email message.

22. The method of claim 17, wherein the notification comprising an image file for a printer demo page.

23. The method of claim 17 further comprising maintaining a list of addresses for each printer demo page in the listing of printer demo pages, each address in the list of addresses being sent the notification in the instance the printer demo page associated with the list of addresses causes the update to the list of printer demo pages.

24. A printer suitable for use with web-based printer demo pages comprising:
a web server web page operable to execute on the printer, the web server web page operable to provide access to a remote computer;
a control panel coupled to the printer, the control panel operable for selecting at least one printer demo page accessible through the remote computer;
a module operable to execute on the printer, the module operable to receive the at least one printer demo page selected using the control panel over a network connection from the remote computer, the module operable to print the at least one printer demo page on the printer.

25. The printer of claim 24 further comprising a storage device coupled to the module, the storage device operable to store the at least one printer demo page received from the remote computer.

26. The printer of claim 24, wherein the remote computer comprising a web site.

27. The printer of claim 24, wherein the remote computer provides a list of web pages for display on the control panel coupled to the printer.

28. The printer of claim 24, wherein the at least one printer demo page is an advertisement.

29. The printer of claim 24, wherein the at least one printer demo page being stored on the remote computer.

30. The printer of claim 24, wherein the at least one printer demo page being stored on a second computer coupled to the remote computer.

31. The printer of claim 24, wherein the control panel displays a list of printer demo pages, wherein the list of printer demo pages is received from the remote computer.
